(19) United States
(12) Patent Application Publication
(10) Pub. No.: US 2026/0292265 A1
(43) Pub. Date: Sep. 24, 2026

(54) Adaptive Spatiotemporal Video Denoise

(71) Applicant: Dimension, Inc., Las Vegas, NV (US)

(72) Inventor: James B Anderson, Minneapolis, MN (US)

(73) Assignee: Dimension, Inc., Las Vegas, NV (US)

(21) Appl. No.: 19/090,310

(22) Filed: Mar. 25, 2025

Related U.S. Application Data
(60) Provisional application No. 63/569,594, filed on Mar. 25, 2024.

(51) Int. Cl. H04N 19/85; G06T 3/4053; G06V 10/30; H04N 19/583; H04N 19/59

(52) U.S. Cl. CPC H04N 19/85; G06T 3/4053; G06V 10/30; H04N 19/583; H04N 19/59

(57) ABSTRACT

Systems and methods for transmitting source video over a bandwidth-limited network. First, high frequency spectral content of the video is encoded into layer-1 data files. In parallel, frames of the video are downsampled and compressed using a lossy CODEC, to define layer-2 data files with high-frequency spectral content removed therefrom. The layer-1 and layer-2 data files are interleaved and are smaller than conventional lossy CODEC compressed files. After receipt, the data files are deinterleaved. The layer-2 data is decompressed and upsampled to create a preliminary reconstructed video. The high frequency spectral content is extracted from the layer-1 data files, and photometric warp superresolution processing restores the high frequency spectral content into the preliminary reconstructed video to generate a final, output video at resolution at or near the source video. An adaptive spatiotemporal noise filtering is applied to each frame of the source video to improve sharpness of the output video.

### CROSS REFERENCE TO RELATED APPLICATION

This application claims priority benefit under 35 U.S.C. § 119(e) to U.S. Provisional Patent Application No. 63/569,594, entitled “Adaptive Spatiotemporal Video Denoise,” filed Mar. 25, 2024, which is hereby incorporated by reference in its entirety, as if set forth in full herein.

### FIELD OF THE INVENTION

The present inventions relate generally to systems, processes, devices, and implementing technologies for video compression and rescaling and, more particularly, to superresolution-enabled video processing which provides improved spatiotemporal video denoise features and functionality.

### BACKGROUND OF THE INVENTION

Terms used herein, and in related applications and issued patents, include but are not limited to: image processing, video processing, video processing pipelines, modulation transfer functions, superresolution (SR), modulation invariance, resampling, video rescaling, nonlinear signal processing (NSP), photometric warp (p-Warp or PW), reconstruction filters, single-frame superresolution (SFSR), superresolution-enabled (SRE) CODECs, video surveillance system (VSS), pattern manifold assembly (PMA), pattern manifold noise-floor (PMNF), video CODECs, additive white Gaussian noise (AWGN), bandwidth reduction ratio (BRR), discrete cosine (spectral) transform (cosine basis) (DCT), edge-contour reconstruction filter (ECRF), fast Fourier (spectral) transform (sine/cosine basis) (FFT), graphics processor unit (GPU), multi-frame superresolution (MFSR), network file system (NFS), non-local (spatiotemporal) filter (NLF), over-the-air (OTA), pattern manifold assembly (PMA), pattern recognition engine (PRE), power spectral density (PSD), peak signal-to-noise ratio (PSNR) image similarity measure, quality-of-result (QoR), raised-cosine filter (RCF), resample scale (“zoom”) factor (RSF), superresolution (super-Nyquist) image processing (SRES), video conferencing system (VCS), video telephony system (VTS), far-infrared (FIR) systems, thermal/far-infrared (T/FIR) systems, near infrared imaging (NIRI), image processing chain, multidimensional filter, nonlocal filter, spatiotemporal filters and spatiotemporal noise filters, thermal imaging, video denoise, minimum mean-square-error (MMSE), Wiener filter, focal-plane array (FPA) sensors, and optical coherence tomography (OCT).

It is well known that video transmission bandwidth demand exceeds network infrastructure capabilities in a number of market sectors incorporating video technologies. This circumstance is primarily due to: (i) increased diversity of software applications leveraging video transport capabilities, (ii) high costs that deter any infrastructure expansion that might be considered, and (iii) an expanding user-base for new products leveraging video transport. From a market development perspective, video transmission bandwidth limitations inherent to global network infrastructure, as it exists today, constitute a significant impediment to product innovation in the video products marketplace. The SRE/CODEC systems, processes, devices, and implementing technologies described herein are intended to address this problem by virtue of a more efficient use of available spectrum.

Currently, lossy CODECs, such as MPEG-4 and H.264/5, predominate in the video products marketplace. These CODECs have proven very successful but have reached technical limits in terms of compression performance. These limits result from the basic block-based/motion-compensated differential encoding mechanism being employed. In other words, with any generic video content, only so much exploitable spatial and temporal redundancy is present. There is thus an on-going need in the industry for improved CODECs that overcomes these limitations.

In preferred embodiments, the SRE/CODEC disclosed and described herein performs no differential encoding whatsoever, but instead employs a spatial encoding of a type very different from that of existing lossy CODECs—with the assumption of a scale-invariant edge-geometry model at a given Nyquist limit, edge-contour content is encoded within a low-bandwidth side-channel. With this encoding, spectra associated with edge-contours may then be discarded in the original image. The bandwidth savings then accrues based upon the fact that any discard of spatial frequencies associated with edge contours is equivalent to symbol-rate reduction (downsampling). This bandwidth savings is significant unto itself. However, the downsampled version of the original source is also available for a successive step of encoding using a lossy CODEC, and it is this combination of SRE/CODEC spatial encoding and lossy CODEC spatiotemporal encoding that exhibits a composite compression ratio as a product of the two component compression ratios.

At a fundamental level, the SRE/CODEC innovations disclosed and described herein introduce a new video system design-tradeoff whereby superresolution processing gain is exchanged for (video) transmission bandwidth. This tradeoff is advantageous in design of such systems where available bandwidth is constrained at a limiting value. In particular, where a more efficient use of available bandwidth becomes possible, more users (and, correspondingly, more content) may be supported. A significant advantage exhibited by the SRE/CODEC innovations disclosed and described herein are their capability to work with existing lossy video CODEC technology to achieve an increased total performance. In particular, the combination of SRE/CODEC, described herein, with known lossy CODECs is capable of maintaining content fidelity at levels of compression far in excess of what is possible using current lossy CODEC technology alone.

In comparison to previous attempts at integration of superresolution and video CODECs, the SRE/CODEC innovations disclosed and described herein do not employ back-propagation superresolution and are thus not subject to well-known deficiencies of the back-propagation formalism. These deficiencies include: (i) relatively high space/time algorithmic complexity impacting computability, and (ii) dependence upon spectral aliasing as the basis for super-Nyquist reconstruction. In the former deficiency, the SRE/CODEC innovations disclosed and described herein employ a direct matched-filter based reconstruction of edge-contours that does not require inversion of an image acquisition model nor any iterative refinement thereof. In this manner, algorithmic complexity is sharply reduced, enabling decreased latency and increased frame rate capability. In the latter deficiency, the decimation-based aliasing upon, which back-propagation superresolution depends, introduces degeneracy in mapping of super-Nyquist spectra that also serves to limit reconstruction accuracy. This problem can be addressed via superresolution processing on a resolution-tree, but only at the cost of a further increase of architectural and algorithmic complexity. A more subtle problem lies with distortion of aliased spectra used as back-projection tracking reference, where a lossy CODEC is applied to (aliased) downsampled content. In effect, a low-frequency noise source is introduced leading to a possibly catastrophic degradation of superresolution reconstruction performance. The fact that the SRE/CODEC superresolution described herein is scale-invariant by construction implies a complete absence of any dependence upon aliasing spectra and, thus, avoids these problems altogether.

It is further known in the industry that “image understanding” hinges upon machine-based information processing on image content, sufficient for detection, segmentation, classification, and association of objects present within an image. For video, which is merely a sequence of image frames, this information processing is naturally extended to a temporal sequence of such frames, whereby relationships amongst objects may then include temporal relationships between such frames. In either case, this information processing is subject to signal-to-noise-ratio (SNR) criteria, as reflected in realization of error rates associated with the aforementioned information processing steps.

As a matter of standard practice, to optimize global SNR, signal conditioning is preferably performed using a tailored processing pipeline which performs its processing steps prior to such information processing of the image content. From a system-theoretic perspective, it logically follows that any such tailored processing pipeline should preferably deliver content at the highest possible SNR to produce a minimum-error output.

Preferably, a signal conditioning pipeline includes (but would not be limited to) denoise, sharpening, and resizing operators. It will be appreciated by one skilled in the art that these operators are often mutually interdependent in terms of system impact. For example, resize operations can also reduce sharpness due to resample interpolation. Similarly, sharpening can reduce SNR due to spectral noise preemphasis. Thus, any resulting system is impacted by performance trade-off decisions, management of which requires global optimization of one form or another. It is therefore desirable for a system to be able to provide generalized resizing without any reduction in SNR or sharpness (resolution). The implied design tradeoff is then side-stepped via use of superresolution reconstruction, whereby mutual interaction amongst the aforementioned signal conditioning operations is effectively eliminated. Stated differently, it is desirable to have a system in which a design constraint is introduced whereby a specific measure on signal quality remains invariant with respect to the resize operation.

The present inventions meet one or more of the above-referenced needs as described herein below in greater detail.

### Summary Of The Inventions

The present inventions relate generally to systems, processes, devices, and implementing technologies for video rescaling using a Nyquist-limited resampling operation under which image modulation transfer is rendered invariant and, more particularly, to superresolution-enabled video processing which provides robust rescaling to arbitrary resolution.

A first aspect of the present inventions is directed to an improved method for transmission of a source video from a first location to a second location, wherein there is limited transmission bandwidth available between the first location and the second location, wherein the source video has a plurality of sequentially-ordered frames of images and has an original spatial sample rate, the source video is encoded to create a compressed video, the compressed video is received at the second location and then decoded and decompressed to create an output video, and the output video is then displayed to one or more recipients, the improved method comprises: encoding the source video to create the compressed video includes the steps of: (i) applying anti-alias, low-pass filtering to the source video; (ii) downsampling the low-pass filtered video to a reduced spatial sample rate lower than the original spatial sample rate, and then (iii) compressing the downsampled video using a lossy codec so that the compressed video has a further reduced spatial sample rate and is smaller in size than the source video; and, after transmitting the compressed video from the first location to the second location, decoding the compressed video includes the steps of: (i) decompressing the compressed video using the lossy codec, (ii) upsampling the decompressed video, and then (iii) applying photometric warp superresolution processing to each frame of the upsampled video to create the output video, wherein the output video has a resolution less than but approaching that of the source video.

In a feature, downsampling the low-pass filtered video to the reduced spatial sample rate defines a source downsampling ratio and the lossy codec compresses the downsampled video at a selected compression rate, wherein the compressed video has a total compression relative to the source video equal to the product of the source downsampling ratio and the selected compression rate.

In another feature, downsampling the low-pass filtered video causes high frequency spectral content from the source video to be discarded and wherein applying photometric warp superresolution processing to each frame of the upsampled video restores a portion of the high frequency spectral content to the output video.

In a further feature, the first location includes a transmitter and the second location includes a receiver.

A second aspect of the present inventions is directed to an improved system for transmission of a source video over a network having limited transmission bandwidth, wherein the source video has a plurality of sequentially-ordered frames of images and has an original spatial sample rate, wherein the source video is converted to a compressed video prior to transmission, and after transmission the compressed video is converted to an output video, and the output video is then displayed to one or more recipients, the improved system comprises: an encoder converts the source video into the compressed video by: (i) processing the source video through an anti-alias, low-pass filter, (ii) downsampling the low-pass filtered video to a reduced spatial sample rate lower than the original spatial sample rate, and then (iii) compressing the downsampled video using a lossy codec so that the compressed video has a further reduced spatial sample rate and is smaller in size than the source video; a transmitter receives the source video from the encoder and transmits the compressed video over the network to a receiver; a decoder receives the compressed video from the receiver generates the output video by: (i) decompressing the compressed video using the lossy codec, (ii) upsampling the decompressed video using an anti-image filter, and then (iii) applying photometric warp superresolution processing to each frame of the upsampled video to create the output video, wherein the output video has a resolution less than but approaching that of the source video.

In a feature, downsampling the low-pass filtered video to the reduced spatial sample rate defines a source downsampling ratio and wherein the lossy codec compresses the downsampled video at a selected compression rate, wherein the compressed video has a total compression relative to the source video equal to the product of the source downsampling ratio and the selected compression rate.

In another feature, downsampling the low-pass filtered video causes high frequency spectral content from the source video to be discarded and wherein applying photometric warp superresolution processing to each frame of the upsampled video restores a portion of the high frequency spectral content to the output video.

In a further feature, the transmitter is in electronic communication with the encoder and the receiver is in electronic communication with the decoder. In another feature, the transmitter is a separate and distinct electronic component from the encoder. In yet a further feature, the receiver is a separate and distinct electronic component from the decoder.

A third aspect of the present inventions is directed to an improved method for transmission of a source video over a network having limited transmission bandwidth, the source video having a plurality of sequentially-ordered frames of images in an uncompressed format and having an original spatial sample rate, the method comprises: for each of the sequentially-ordered frames of images of the source video, generating one or more edge contour reconstruction filter instances associated therewith, wherein each of the one or more edge contour reconstruction filter instances encodes high frequency spectral content of the associated frame, each encoded frame defining a stage one compression data file associated with a respective stage one image frame of the source video; downsampling the source video to remove high-frequency spectral content from each of the sequentially-ordered frames of images; compressing each of the sequentially-ordered frames of images of the downsampled source video using a lossy codec so that the compressed video has a reduced spatial sample rate lower than the original spatial sample rate and is smaller in size than the source video, each downsampled and compressed frame defining a stage two compression data file associated with a respective stage two image frame of the source video; interleaving the stage one compression data files with the stage two compression data files to define a compressed video packet associated with each stage one and stage two image frames, the compressed video packet having a smaller data file size than that of the corresponding, uncompressed image frame of the source video; transmitting one or more of the compressed video packets associated with the source video from a transmitter at a first location, over the network having limited transmission bandwidth, to a receiver at a second location; after receipt of one or more of the compressed video packets by the receiver, deinterleaving the compressed video packet to separate the stage one and stage two compression data files associated with each respective stage one and stage two image frame of the source video; decompressing each stage two compression data file using the lossy codec; upsampling the decompressed stage two compression data file to define a preliminary reconstructed frame associated with the corresponding frame of the source video, the preliminary reconstructed frame having a predetermined resolution less than the source resolution; extracting each of the one or more edge contour reconstruction filter instances from the stage one compression data file to obtain the high frequency spectral content associated with each respective frame of the source video; associating the extracted high frequency spectral content associated with each respective frame of the source video with its corresponding preliminary reconstructed frame; applying photometric warp superresolution processing to each preliminary reconstructed frame to restore the high frequency spectral content associated therewith and to generate an output video defined as a full-Nyquist reconstruction of each respective frame of the source video; and displaying the output video to a viewer at the second location.

In a feature, the step of generating one or more edge contour reconstruction filter instances associated with each of the sequentially-ordered frames of images comprises applying a nonlinear filter transformation to each of the sequentially-ordered frames of images, the output of which is a pattern manifold assembly (PMA) representation, wherein the PMA representation is an analytic image representation in which edge contours of the respective frame are emphasized. Preferably, the one or more edge contour reconstruction filter instances are extracted from corresponding PMA representations. Additionally, a gradient tracking loop provides an adaptive noise minimum threshold for selecting and discarding PMA representations.

In another feature, each edge contour reconstruction filter instance identifies a respective edge contour defined by its coordinate localization, curvilinear geometry, and orientation.

In a further feature, each stage one compression data file includes descriptor fields associated with each of the one or more edge contour reconstruction filter instances associated with the respective frame and identification of the respective edge contour associated with each corresponding edge contour reconstruction filter instance.

In yet another feature, each stage one compression data file includes x,y coordinates associated with each respective edge contour reconstruction filter instance associated with the respective frame along with variable values necessary for full-Nyquist reconstruction of the respective frame of the source video at the source resolution.

In further features, the step of interleaving the stage one compression data files with the stage two compression data files comprises embedding information from the stage one compression data files into one of: lossy-CODEC data fields of the stage two compression data files, extended or auxiliary IPv6 data fields of the compressed video packets, and separate data packets and IP addresses linked with the corresponding stage two compression data files.

In some embodiments, the source video is a pre-recorded video or a live streaming video.

In other embodiments, the source video (i) originates from one of a plurality of first locations and is transmitted to a single second location, (ii) originates from a single first location and is transmitted to one or more second locations, or (iii) is a shared conference video originating from and transmitted between a plurality of first and second locations.

In other aspects, the methods and systems described herein further comprise applying photometric warp superresolution processing to each frame of the source video prior to the step of encoding to improve the sharpness of the output video.

Preferably, buffering is applied to the gradient field, to the pattern manifold, and to each frame of the source video. The gradient field and the pattern manifold are preferably buffered separately and buffering of each frame of the source video is rendered cyclic.

In another feature, the gradient field, the pattern manifold, and each respective frame of the source video are not overwritten in buffer memory until the step of applying photometric warp superresolution processing to each respective frame of the source video is completed.

The aspects of the invention also encompass a computer-readable medium having computer-executable instructions for performing methods of the present invention, and computer networks and other systems that implement the methods of the present invention.

The above features as well as additional features and aspects of the present invention are disclosed herein and will become apparent from the following description of preferred embodiments.

This summary is provided to introduce a selection of aspects and concepts in a simplified form that are further described below in the detailed description. This summary is not intended to identify key features or essential features of the claimed subject matter, nor is it intended to be used to limit the scope of the claimed subject matter.

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In addition, further features and benefits of the present technology will be apparent from a detailed description of preferred embodiments thereof taken in conjunction with the following drawings, wherein similar elements are referred to with similar reference numbers, and wherein:

FIGS. 1(a)-1(e) illustrate several exemplary high-level system architectural templates incorporating the SRE/CODEC functionality disclosed and described herein.

FIG. 2 illustrates a photometric warp single frame superresolution model that employs an edge-luminance to provide scale invariance with a minimal pixel support for use with the methods and systems described herein.

FIG. 3 illustrates an image or single frame of a source video showing the use of gradient supports.

FIG. 4 illustrates edge detection instances, with their components, as used with an image or single frame of a source video similar to that shown in FIG. 3.

FIG. 5 illustrates an exemplary PW/SRSR component as disclosed and described herein.

FIG. 6(a) illustrates an SRRS component in which a PW/SFSR component is included prior to upscaling and downscaling components disclosed and described herein.

FIG. 6(b) illustrates a VPC used with an SRRS component similar to that shown in FIG. 6(a).

FIG. 7 illustrates an exemplary Artificial Intelligence application for use with the components shown in FIGS. 5, 6(a), and 6(b), as disclosed and described herein.

FIG. 8(a) illustrates a “Source-Encoded” SRE/CODEC model, in which Pattern Manifold Assembly (PMA) and Edge-Contours Reconstruction Filter (ECRF) instancing are performed at the transmitter, for use with the systems of FIGS. 1(a)-1(e).

FIG. 8(b) illustrates a “Source-Encoded” SRE/CODEC model, in which a VPS/SRRS component is substituted for the Pattern Manifold Assembly (PMA) and Edge-Contours Reconstruction Filter (ECRF) instancing of FIG. 8(a).

FIG. 9 illustrates a flow chart of an exemplary adaptive spatiotemporal video denoise system, as disclosed and described herein.

### DETAILED DESCRIPTION OF PREFERRED EMBODIMENTS

Before the present technologies, systems, devices, apparatuses, and methods are disclosed and described in greater detail hereinafter, it is to be understood that the present technologies, systems, devices, apparatuses, and methods are not limited to particular arrangements, specific components, or particular implementations. It is also to be understood that the terminology used herein is for the purpose of describing particular aspects and embodiments only and is not intended to be limiting.

As used in the specification and the appended claims, the singular forms “a,” “an,” and “the” include plural referents unless the context clearly dictates otherwise. Similarly, “optional” or “optionally” means that the subsequently described event or circumstance may or may not occur, and the description includes instances where the event or circumstance occurs and instances where it does not. Throughout the description and claims of this specification, the word “comprise” and variations of the word, such as “comprising” and “comprises,” mean “including but not limited to,” and is not intended to exclude, for example, other components, integers or steps. “Exemplary” means “an example of” and is not intended to convey an indication of preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference to each various individual and collective combinations and permutations of these cannot be explicitly disclosed, each is specifically contemplated and described herein, for all methods and systems. This applies to all aspects of this specification including, but not limited to, steps in disclosed methods. Thus, if there are a variety of additional steps that can be performed it is understood that each of the additional steps can be performed with any specific embodiment or combination of embodiments of the disclosed methods.

As will be appreciated by one skilled in the art, the methods and systems may take the form of an entirely new hardware embodiment, an entirely new software embodiment, or an embodiment combining new software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, non-volatile flash memory, CD-ROMs, optical storage devices, and/or magnetic storage devices.

Embodiments of the methods and systems are described below with reference to block diagrams and flowchart illustrations of methods, systems, apparatuses and computer program products. It will be understood that each block of the block diagrams and flow illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions, and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

### A. Overview

Video CODECs, such as Motion JPEG (MJPEG), H.264, and MPEG-4, have found widespread acceptance as video compression solution in today's marketplace. In principle, compression ratios at three orders of magnitude are possible with these technologies. However, in many applications of interest, the fact these CODECs employ lossy block-based differential encoding limits useful compression to a more moderate 20:1-40:1 range. From an information theoretic perspective, this reduction may be regarded as manifestation of the fact, at the scale of a given blocksize, only so much redundancy of a given type is present in any image sequence. One consequence of this is that an overly aggressive redundancy-based encoding is prone to create excessive artifacts and unacceptably high noise levels in an output image.

While block-based differential video compression has proven very successful, the inherent performance limitations of this approach also serve to hinder evolution of video system applications for which an increased level of compression performance is critical or desirable. In the SRE/CODEC innovation disclosed and described herein, a complementary approach in which superresolution is applied to an extension of useful compression ratios for these techniques is taken. This is possible by virtue of the fact that superresolution upscaling is by definition super-Nyquist. That is to say, superresolution reconstruction filtering synthesizes spectral content according to an assumed structural model. An important point is that the structural model is not included with transmission payload and may thus be leveraged as the basis for an optimal encoding of synthesized spectra. An increased compression then hinges upon the fact optimal encoding of all or part of an image implies a reduced bandwidth requirement. That is to say, any excess bandwidth associated with transmission of the non-encoded version may in principle be discarded. This is in fact the conceptual basis of superresolution-based compression.

In one implementation, video transmission payload is cast in terms of a logical sum of objects plus edge-contours bordering objects. Edge-contours are then optimally encoded in terms of superresolution reconstruction filters instanced at specific coordinates. Associated spectra are then discarded pre-transmission to an extent consistent with reconstruction at some imposed accuracy criterion. Where the specific case of edge-contour encoding is considered, spectra are generally isolated to highest spatial frequencies that may be removed via a tailored downsampling process.

This downsampled source is itself available for encoding via an ancillary CODEC. With application of such encoding, total compression is then given by a product of edge-contour reconstruction compression and lossy CODEC compression in what amounts to a two-stage succession of CODEC transformations. As described hereinafter, this novel concept forms the basis of a Superresolution-Enabled video CODEC (SRE/CODEC) that optionally leverages some lossy CODEC, such as H.264/MPEG-4/MJPEG, as a second layer. This construct is then shown capable of ‘x4’, ‘x16’ increased compression ratios relative to the lossy CODEC alone.

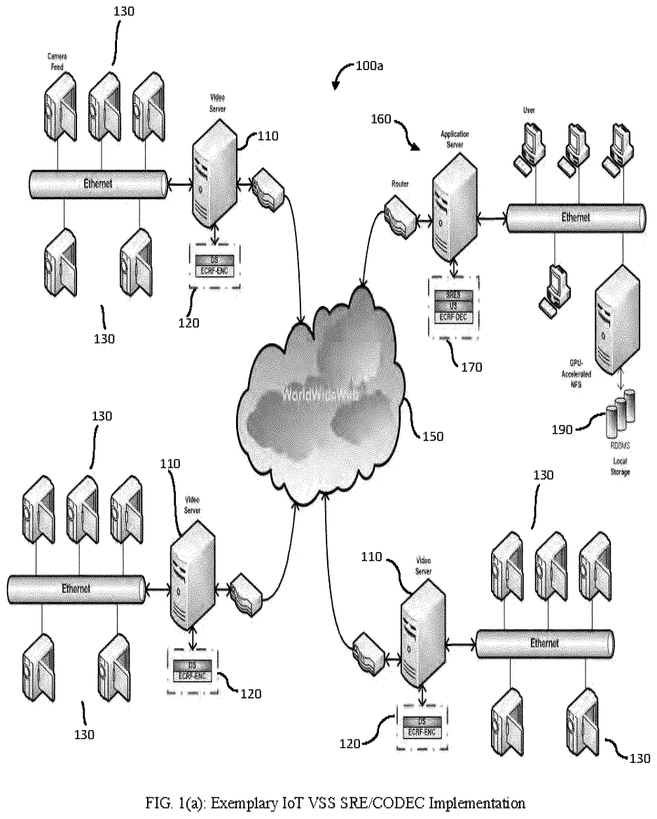

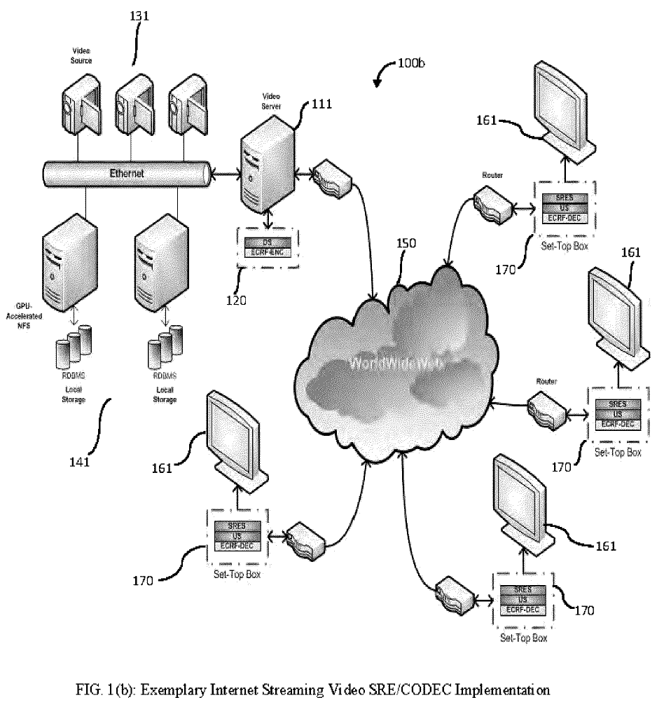

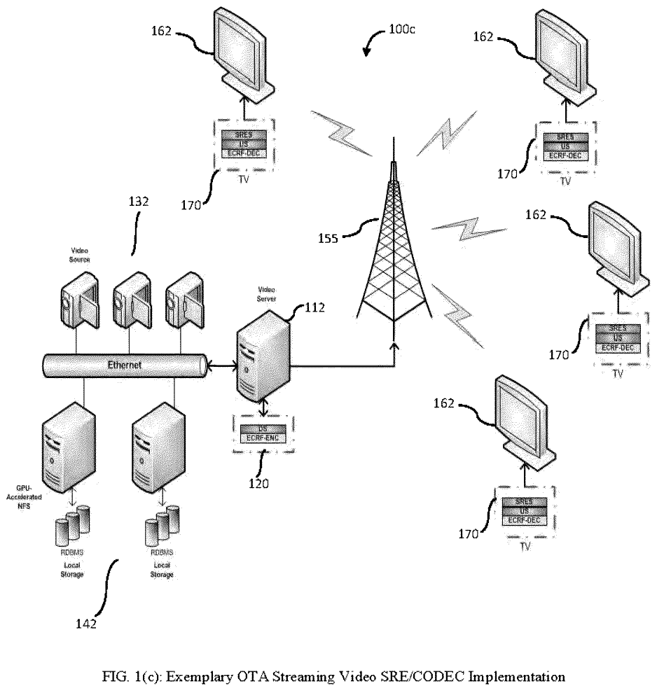

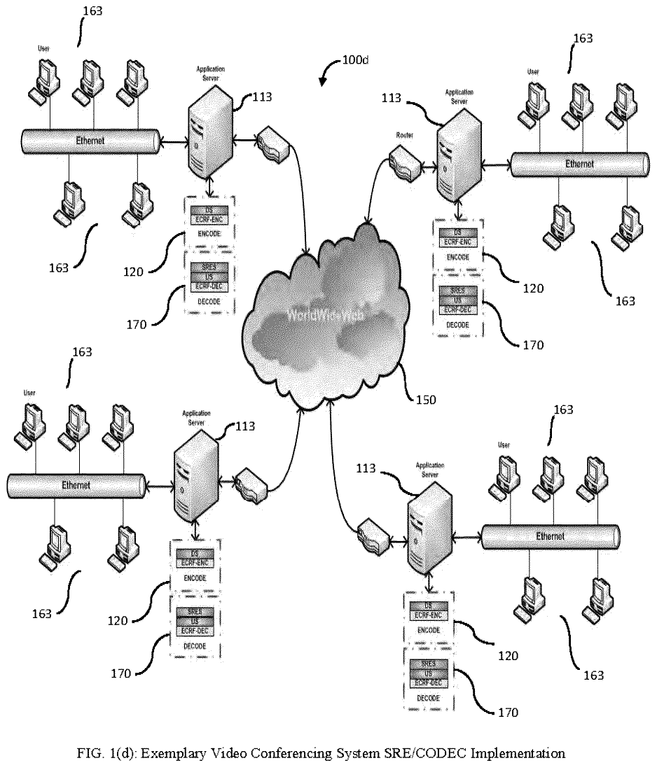

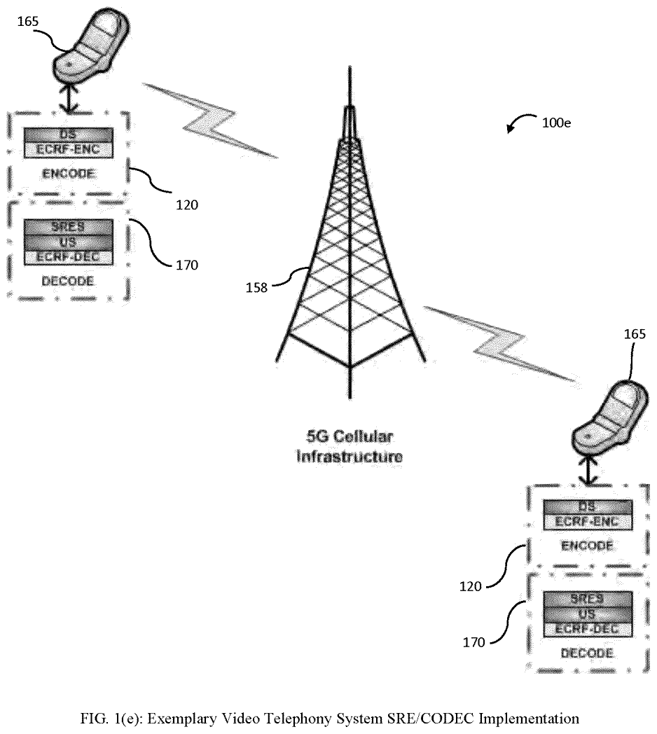

Exemplary SRE/CODEC system applications include but are not limited to: (i) Video Surveillance, (ii) Streaming Video, (iii) Video Conferencing, and (iv) Video Telephony. FIGS. 1(a)-(d) illustrate at a high level several of these exemplary system architectural templates incorporating SRE/CODEC functionality. Each architectural template is tailored to a specific business or use application for which enhanced SRE/CODEC compression enables an increased network capacity.

Specifically, FIG. 1(a) provides a generic Internet-of-Things (IoT)-based Video Surveillance System (VSS) 100a incorporating Internet video transport over a network 150 from multiple satellite camera-feed aggregation point Video Servers 110 to a centralized monitoring location or facility 160 that implements the SRE/CODEC processes and technology described herein. In this system 100a, superresolution ENCODE/DECODE block-components 120, 170, respectively, are distributed to remote edge-compute Video Servers 110 and to the centralized monitoring facility 160. The remote edge-compute Video Servers 110 aggregate video from a plurality of distinct camera-feeds 130, the videos are encoded, transmitted over the network 150 to the centralized monitoring facility 160, decoded, and then viewed, analyzed, and/or stored in data storage 190.

FIG. 1(b) illustrates an Internet-based Streaming Video system 100b incorporating SRE/CODEC processes and technology described herein. In this system 100b, ECRF ENCODE/DECODE, Upsample/Downsample (US/DS), and Superresolution (SRES) block-components 120, 170, respectively, are distributed to content provider video servers 111 and a plurality of set-top-boxes 161 located at remote user locations. Streaming video content may be derived from live-video sources 131 or NFS archive repository sources 141. The videos are encoded, transmitted over the network 150 to the plurality of set-top-boxes 161, decoded, and then viewable on the set-top-boxes 161.

FIG. 1(c) illustrates an Over-the-Air (OTA) Streaming Video 100c incorporating SRE/CODEC processes and technology described herein. In this system 100c, ECRF ENCODE/DECODE, Upsample/Downsample (US/DS), and Superresolution (SRES) block-components 120, 170, respectively, are distributed to content provider video servers 112 and a plurality of televisions 162 located at remote user locations. Streaming video content may be derived from live-video sources 132 or NFS archive repository sources 142. The videos are encoded, transmitted over the air using conventional broadcast networks 155 to the plurality of televisions 162, decoded, and then viewed by end users on the televisions 162.

FIG. 1(d) illustrates a generic Video Conferencing System (VCS) 100d incorporating SRE/CODEC processes and technology described herein. VCS data transport is inherently bidirectional requiring access to ECRF ENCODE/DECODE, Upsample/Downsample (US/DS), and Superresolution (SRES) block-components 120, 170, respectively, for all users 163. In this specific embodiment, VCS is also distributed with incorporation of remote internet network connections. Thus, for considerations of increased efficiency and reduced cost, SRE/CODEC services are preferably localized, as shown, at application servers 113 aggregating VCS web-traffic distributed bidirectionally over the network 150.

FIG. 1(e) illustrates a generic Video Telephony System (VTS) 100e incorporating SRE/CODEC processes and technology described herein. Similar to VCS data transport, VTS data transport is inherently bidirectional over a cellular or data network 158. Thus, each user mobile device/videophone 165 preferably includes access to full SRE/CODEC functionality, including ECRF ENCODE/DECODE, Upsample/Downsample (US/DS), and Superresolution (SRES) block-components 120, 170, respectively, for each user mobile device/videophone 165.

In such system applications, bandwidth constraints become active with presence of an arbitrarily large number of individual feed or channels located at network aggregation points. In this context, SRE/CODEC compression provides an obvious performance benefit based upon bandwidth reduction at each video feed.

In a further enhancement, total realizable compression is increased as a result of edge-contour lossless encoding at full (source) resolution, whereby photometric warp edge-dislocation noise and edge-contour extrapolation noise sources are effectively eliminated. Further, the fact that this encoding is performed at source resolution, (i.e. pre-downsampling), enables super-Nyquist reconstruction in combination with an increased total compression.

In further embodiments, the following concepts are disclosed and described herein: PW/SFSR superresolution formalism; PW/SFSR architecture; PW/SFSR Nyquist refinement; SRRS architecture; SRRS modulation invariance, processing gain; VPC/SRRS architecture; VPC/SRRC enhanced applications; VPC/SRRS enhanced SREC architecture; and VPC/SRRS enhanced SREC application templates. Further, the following will also be discussed herein: relation between PW/SFSR and Nyquist Rate; PW/SFSRNR that does not induce Gibbs phenomenon; PW/SFSR concepts extensible to other line/boundary models; Gradient/Laplacian operator selections; Additive-plus-Multiplicative noise models; modulation optimization; and modulation-invariant designs.

In summary, preferred embodiments disclosed and described herein include, but are not limited to: unified rescaling models; scale invariant reconstruction; modulation-invariant design methodologies; complete VPC systems with processing gain; and implementations easily targeted to GPU-accelerated workstations, cloud environments, and the like.

As described hereinafter, it is desirable to have a photometric warp-based (‘pWarp’ or PW) single-frame-superresolution (SFSR) and standard resampling operators that provide rescaling capability that not only resamples but also imposes a resolution-invariant reconstruction at the information processing input. As will be shown herein, under circumstances where image sharpness or resolution is subject to symmetric blurring, any such blurring may be cast as a noise-like process in which implication resolution invariance may itself be cast in terms of SNR invariance.

Any discussion of SNR necessarily presupposes the presence of one or more noise processes. Accordingly, where video or image rescaling is considered, there are three predominant noise sources: (i) additive (e.g., ‘thermal’); (ii) multiplicative (e.g. ‘mosquito’); and (iii) modulation or modulation transfer. Preferred embodiments described herein focus upon the latter modulation noise process, with additive and multiplicative sources treated separately as a unified additive process. Thus, modulation noise is cast in terms of deviation from a collocated luminance prototype, as shown in Equation (1) below:

$${σ}_{m}^{2} = \int {( {L}_{m} ( x , y ) - {L}_{ec} ( x , y ) )}^{2} dxdy - {σ}_{U}^{2} \qquad ( 1 )$$

where:
Lₘ=Luminance modulation prototype
L_{ec}=Edge-contour luminance
σₘ=Modulation noise SD
σᵤ=Unified (additive plus multiplicative) noise SD

It then follows that ‘Lₘ,’ defined in terms of a matched-filter template, enables scale-invariant characterization of modulation noise relative to a sharpest possible image. Thus, this relation forms the basis of a superresolution principle by which the proposed rescaling operator is itself rendered scale-invariant in terms of modulation noise transfer.

As shown herein, three distinct variants arise within context of rescaling operations, each of which preferably requires separate treatment: (i) upscaling, (ii) downscaling, and (iii) identity. In each case, modulation transfer (MTF), as shown in Equation (2) below, is constrained by:

$$MTF = 10 {log}_{10} ( \frac{{σ}_{{m}_{OUT}}^{2}}{{σ}_{{m}_{IN}}^{2}} ) = 0 , {σ}_{{m}_{OUT}}^{2} \geq {σ}_{{m}_{IN}}^{2} \qquad ( 2 )$$

where satisfaction of the latter constraint is assured via a Nyquist refinement process applied at rescaler input, as shown in Equation (3) below, whereby:

$$∧ ( x , y ) ( {L}_{ec} ( x , y ) = {L}_{m} ( x , y ) ) \qquad ( 3 )$$

As shown herein, these constraints are applied to all three rescaler variants to create an integrated superresolution-enabled rescaler processing system (SRRS) comprised of a succession of resampling and reconstruction processing steps.

### B. Single-Frame Superresolution

Photometric Warp (‘pWarp’ or PW) is defined as an image processing technique in which luminance of any image pixel is rendered dependent upon an auxiliary function of some form. Accordingly, pWarp superresolution is obtained where the referenced auxiliary function is also a reconstruction operator. Further, where the reconstruction operator domain is a single frame, the resulting superresolution construct is defined as a single-frame superresolution (‘SFSR’).

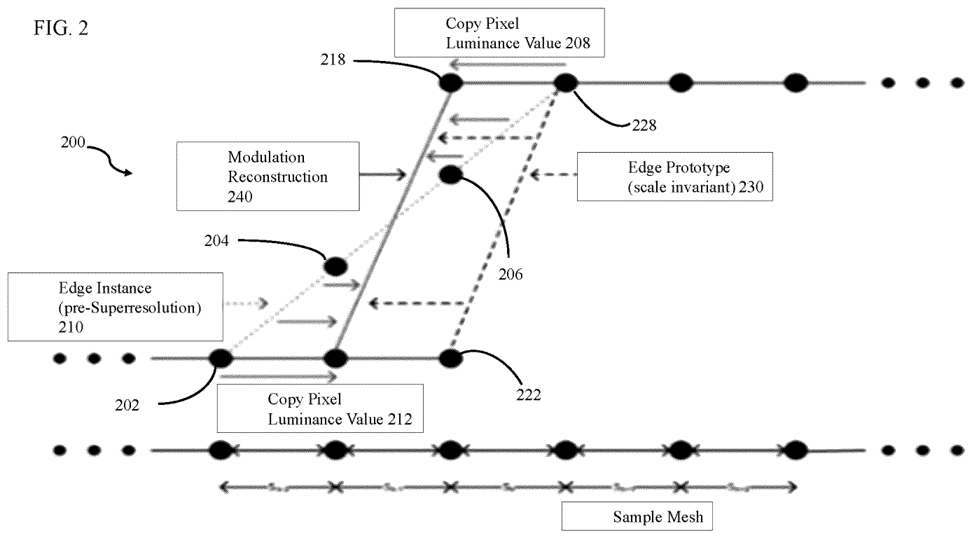

As shown in FIG. 2, a particular pWarp SFSR used herein employs an edge-luminance model 200 that is both symmetric and scale invariant. In this instance, model symmetry is motivated by an assumed symmetry associated with the fundamental edge-blurring process. Scale-invariance is then assured via a minimal pixel support to which a set of gradient operators are applied for edge-structure detection. In essence, luminance of a detected edge 210 is modified so as to exactly match the luminance model. As an example, support for the edge prototype 230 displayed in FIG. 2 is reduced from 4-pixels pre-Warp 202,204,206,208 to 2-pixels post-Warp 222,228 in generation of a 300% increased slope (sharpness) post-superresolution 240, shown by pixels 212,218. Thus, pWarp SFSR extends this edge-reconstruction model 200 to arbitrary curvilinear structures via directional correlation along edge-detection contours.

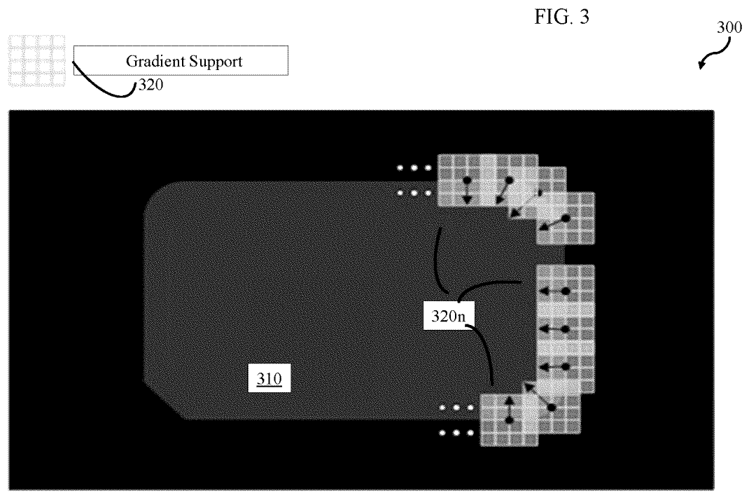

In FIG. 3, an exemplary image 300 consisting of a single object 310 is displayed. In this representation, color-coded edge-detection events and associated gradient support 320 are indicated along the object periphery 320n. As implied by the schematic representation in FIG. 2, post-reconstruction ‘edges’ necessarily resolve at support pixel interstices. That is to say, while gradient support representation requires some number of pixels, edge-representation requires no additional pixels. Thus, the notion of ‘edge’ may be considered virtual in the sense that presence of an edge is unambiguously implied by a luminance transition which is formally represented as a spatial derivative, the locus of which is constrained by the aforementioned blur symmetry to accrue on a pixel boundary.

### C. Pattern Manifold

Two technical requirements for robust edge-localization thus emerge: (i) symmetric gradient approximation, and (ii) subpixel resolution. In this context, symmetric approximation at subpixel resolution implies unbiased edge-localization with approximation error magnitude of less than the span of a single pixel. A pattern manifold construct, based upon a tailored nonlinear filter, is preferably used to achieve this accuracy. Accordingly, such pattern manifold ‘M’ is defined as an analytic map generated on a local gradient field, as set forth in Equation (4) below:

$$M = \vert R \cdot G \vert = \vert {e}^{- δ \vert {∇}^{2} P \vert} \frac{∇ P}{{‖ ∇ P ‖}_{∞}} \vert \qquad ( 4 )$$

where:
M=Pattern manifold
R=Edge refinement function
G=Gradiant at
P=Local patch
δ=Optima ‘peaking’ parameter (δ∈R⁺)
∇=Spatial gradient operator
∇²=Spatial Laplacian operator

Accordingly, the pattern manifold value at x-y pixel coordinate ‘{i,j}’ is given by:

$${M}^{ij} = \vert {R}^{ij} \cdot {G}^{ij} \vert = \vert {e}^{- δ \vert {∇}^{2} {P}^{ij} \vert} \frac{∇ {P}^{ij}}{{‖ ∇ P ‖}_{∞}} \vert \qquad ( 5 )$$

for which an edge-instance is indicated by sufficient conditions for a local extremum along a directional derivative, as shown by Equation (6):

$${D}_{{\to }_{v}} {M}^{ij} = 0 , {D}_{{\to }_{v}}^{2} {M}^{ij} > 0 \qquad ( 6 )$$

The singular advantage of this formulation over a simple gradient field is, depending upon the value assigned to ‘δ’, valid edge-detection events will exhibit uniform local maxima on ‘M^{ij}’. It then follows that deletion of manifold entries not locally maximal effectively deletes spurious detections. This is equivalent to a thinning process for which intensity parameter ‘δ’ may be adjusted such that the extremal structure upon which thinning depends may be accentuated to whatever degree required. In what follows, cross-correlation on neighboring edge-detections generate curvilinear edge-structure to which a reconstruction process may be applied.

### D. Photometric Warp Single-Frame Superresolution

Photometric warp (‘pWarp’ or PW) is preferably defined in terms of an algorithmic process by which edge-contours are first localized using Equations (4) and (5), above, and then reconstructed according to a scale-invariant model 200 (see FIG. 2). As described herein, use of the term photometric is understood to imply reconstruction in color-magnitude (luminance) space. However, unambiguous edge-detection requires independent evaluation of Equation (5) on each color-plane. Accordingly, sufficient conditions for an edge instance in luminance-space is given by satisfaction of Equation (6) for each/any color plane, as set forth in Equation (7):

$${D}_{{\to }_{v}} {M}_{R ‖ G ‖ B}^{ij} = 0 , {D}_{{\to }_{v}}^{2} {M}_{R ‖ G ‖ B}^{ij} > 0 \qquad ( 7 )$$

Color-magnitude (luminance) for any pixel is then given by Equation (8), as follows:

$${p}_{L}^{ij} = \sqrt{{{\to }_{p}}^{ij} \cdot {{\to }_{p}}^{ij}} = \sqrt{‖ {{\to }_{p}}^{ij} ‖ ‖ {{\to }_{p}}^{ij} ‖} s . t . {{\to }_{p}}^{ij} = ( {p}_{R} , {p}_{G} , {p}_{B} ) \qquad ( 8 )$$

Thus, photometric warp is understood as an algorithmic process by which luminance of pixels surrounding an edge-contour are adjusted to match those of an assumed luminance model. For this purpose, a warping function is employed on support pixels adjacent to an edge contour, according to proximity and orientation. Thus, at the Nth output frame, pixel luminance is modified via the recurrence relation of Equation (9):

$${p}_{L}^{ij} = \frac{{\sum }_{k , l} {w}_{k , l} {p}_{L}^{k , l}}{{\sum }_{k , l} {w}_{k , l}} \vert i , j ∈ [ 1 , M ] \qquad ( 9 )$$

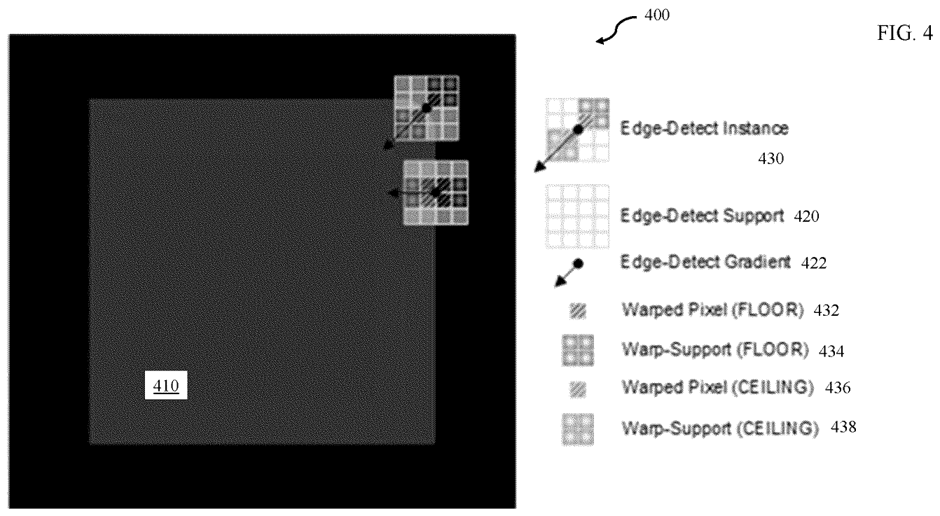

with ‘w_{k,l}’ defining a weighting function on the normed distance from edge-detection coordinates. In this manner, support pixels may be assigned luminance values according to proximity and orientation relative to coordinates at which an edge is detected. The exemplary pixel-warp representation 400 of image 410 displayed in FIG. 4 highlights the relationship between pattern manifold processing and pixel-warp, whereby an edge-detection instance 430, which comprises an edge-detect support 420, an edge-detect gradient 422, one or more warped pixels (floor) 432 within the warp support (floor) 434, and one or more warped pixels (ceiling) 436 within the warp support (ceiling) 438, which triggers warp-support calculation followed by photometric-warp.

As a matter of structural consistency, pixels contributing to edge detection and localization are included in a preimage for warp-support. Thus, pattern manifold support necessarily subtends warp-support. Further, the indicated discrimination of warp-support pixels according to edge FLOOR or CEILING, metric distance from the edge-detection coordinates, and angular orientation relative to the gradient vector jointly imply an indexing relation on weights appearing in the warping function. Accordingly, Equation (9) is modified to incorporate indexed selection of pixels to be included as elements of a warp-support set, as set forth in Equation (1) below:

$${p}_{L}^{ij} = \frac{{\sum }_{k , l} {idx}_{kl} {w}_{k , l} {p}_{L}^{k , l}}{{\sum }_{k , l} {idx}_{kl} {w}_{k , l}} = \frac{{\sum }_{k , l} {\hat{w}}_{k , l} {p}_{L}^{k , l}}{{\sum }_{k , l} {\hat{w}}_{k , l}} \vert i , j ∈ [ 1 , N ] \qquad ( 10 )$$

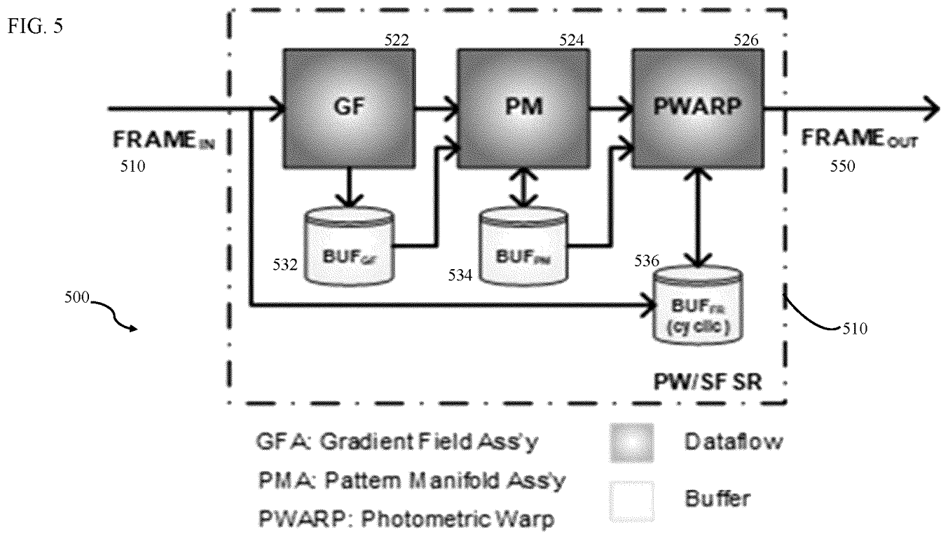

A block-level dataflow representation 500 for PW/SFSR 520 is displayed in FIG. 5, as a feedforward succession of gradient field assembly (GFA) 522, pattern manifold assembly (PMA) 524, and photometric warp (PWARP) 526 blocks, with corresponding buffers 532, 534, 536, respectively, described below. The frame input (FRAME_{IN}) 510 is fed into the PW/SFSR 520 and generates the scaled output frame (FRAME_{OUT}) 550. At this level of abstraction, the PW/SFSR process is reduced to a preferred 5-step sequence: (i) READ/Buffer input-frame (FRAME_{IN}); (ii) calculate gradient-field (GF); (iii) calculate pattern-manifold (PM); (iv) apply photometric-warp (PWARP); and (v) WRITE output-frame (FRAME_{OUT}).

Implementation of internal data-buffering remains flexible but is also subject to a set of algorithmic constraints relating to data-persistence requirements as implied by Equations-(5) and (6). In simplest terms, no one of the gradient field, pattern manifold, or input frame can be overwritten until PWARP processing is complete. Accordingly, the gradient-field and pattern manifold are buffered separately (BUF_{GF}, BUF_{PM}), 532, 534 and the frame-buffer (BUF_{FR}) 536 is rendered cyclic.

### E. Modulation Transfer

A modulation-function is then defined, in terms of image luminance response along a specified contour, presumably transversing some curvilinear object boundary of interest, as set forth in Equation (11) below:

$${f}_{MOD} ≡ L ( x , y ; a , b , c ) \vert ax + by = c \qquad ( 11 )$$

The utility of this function, Equation (11), when combined with a known reference test-pattern, rests in quantization of edge-blurring, whereby not only the sharpness of a given image but also changes in sharpness as a modulation transfer effect are assessed. As an example, with assumption of the scale-invariant grating-model, a modulation-transfer response for some assumed image transformation can be calculated. In principle, it is only necessary to evaluate Equation (1) at dataflow input and output, and with this information, evaluate Equation (2) as a noise-transfer effect.

By inspection, it is also apparent that:

$${σ}_{{m}_{OUT}}^{2} > {σ}_{{m}_{IN}}^{2} \qquad ( 12 )$$

Whereby Equation (12) implies a reduced sharpness at the output. Further, using Equation (2), and with no additional noise filtering, an increased noise amplitude is indicated at the output, which will be discussed in greater detail below.

### F. SRRS Architectural Form

As stated in the introduction, a Superresolution-enabled Resampler (SRRS) pertains to rescaling operations on video or images and may be represented as but one block-component of an image processing pipeline. It should be understood that there is a distinction between the terms ‘rescale’ and ‘resize’. As is commonly understood, ‘resize’ implies resampling to an increased or decreased image size, the primary motivation for which is management of formal complexity as part of follow-on processing blocks. This can be stated as a general principle whereby all processing subsequent to the image processing pipeline is performed at lowest possible resolution. It then follows, resolution may be higher or lower than a given input resolution, per a specific application scenario. As described herein, the previously discussed pWarp superresolution is added as a step to correct reduced sharpness that may accrue due to the filtering and interpolation operations that comprise a resizing transformation, superresolution-based reconstruction of which is then elevated to definition of an image rescale operation.

In most general terms, superresolution QoR critically depends upon input image quality. In particular, noise or blurring that may be present in an input image will degrade follow-on superresolution performance. This is also true of pWarp superresolution, which motivates emplacement of noise filtering and Nyquist refinement blocks within context of an SRRS architectural form. The term Nyquist Refinement (NR) is understood to imply application of superresolution reconstruction to an image with image size held invariant. That is to say, no upsample or downsample is performed. Here, NR is employed as a means to optimize modulation transfer prior to resampling, interpolation, and superresolution reconstruction, and in doing so assure highest possible rescaler QoR.

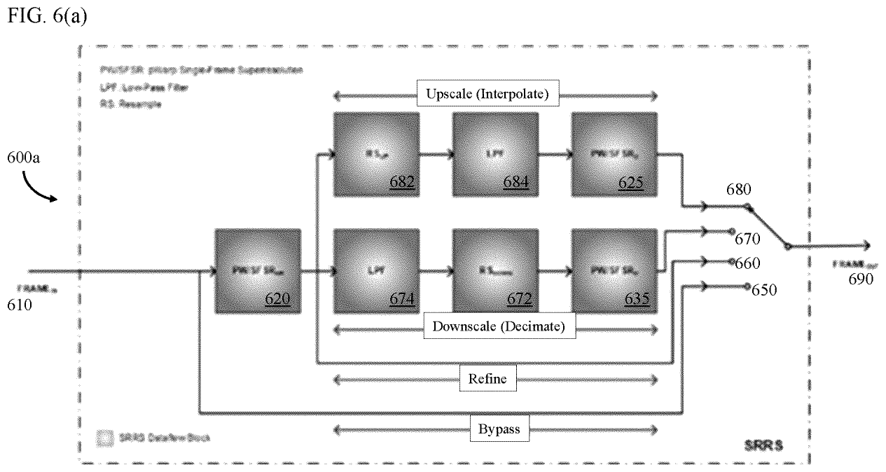

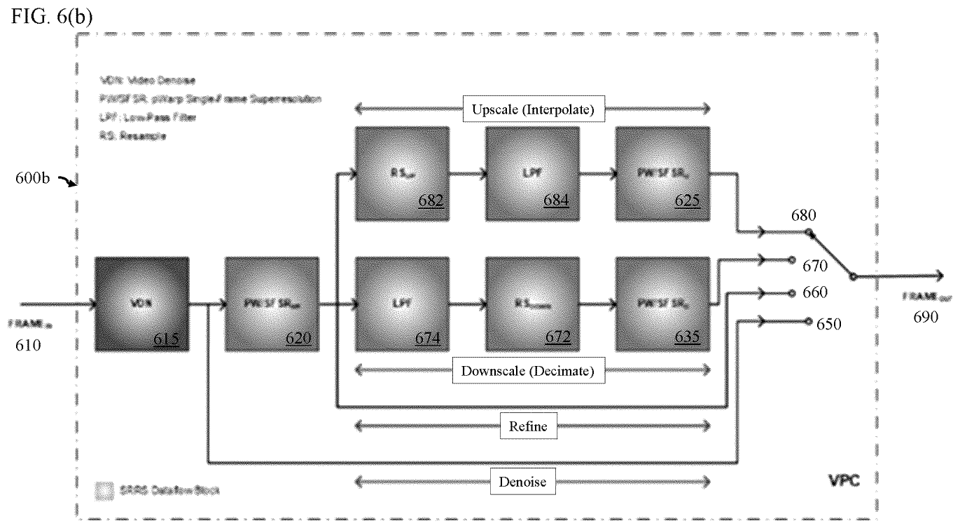

Accordingly, as shown in FIG. 6a, a complete SRRS architectural form 600a consisting of an initial PW/SFSR_{NR} block 620, followed by user-selectable UPSCALE, DOWNSCALE, REFINE, and BYPASS pathways 680, 670, 660, 650, respectively. The UPSCALE pathway 680 includes the steps of receiving the input frame (FRAME_{IN}) 610 after it has been subject to Nyquist refinement through initial PW/SFSR_{NR} block 620, resampling (up) 682, low-pass filtering/interpolation through block 684, and then upscaling using PW/SFSR_{U} block 625, resulting in upscaled output frame (FRAME_{OUT}) 690. The DOWNSCALE pathway 670 includes the steps of receiving the input frame (FRAME_{IN}) 610 after it has been subject to Nyquist refinement through initial PW/SFSR_{NR} block 620, low-pass filtering/interpolation through block 674, then resampling (down) 672, and then downscaling using PW/SFSR_{D} block 635, resulting in downscaled output frame (FRAME_{OUT}) (not numbered). As might be expected, each respective PW/SFSR block 625,635 exhibit identical functionality, albeit with output at distinct upscaled or downscaled resolution. The REFINE pathway 660 includes the steps of receiving the input frame (FRAME_{IN}) 610 after it has been subject to Nyquist refinement through block 620 but then propagating PWARP_{NR} output directly to SRRS output, (i.e., at SRRS input resolution).

It will be appreciated that block placement impacts modulation transfer performance realization in the SRRS architectural form 600a. In particular, the gradient and Laplacian operators cited in Equations (4) and (5) (re: PW/SFSR_{NR,U,D} pattern manifold assembly) are known to exhibit noise preemphasis. Further, PW/SFSR itself is known to exhibit amplitude and edge-displacement noise responses that can be expected to impact edge-contour reconstruction accuracy. SRRS addresses these problems with insertion of PW/SFSR_{NR} as a (modulation) noise reduction step prior to the UPSCALE and DOWNSCALE processing described above, whereby modulation-transfer is optimized based upon an improved pattern manifold response for follow-on PW/SFSR_{U,D} blocks 625, 635, respectively.

### G. SRRS/VPC Application Templates

SRRS 600a as a technology component can be combined with other processing blocks to create a variety of useful functionalities. For example, FIG. 6b illustrates a complete video preconditioning system (VPC) architectural form 600b featuring SRRS functionality shown in FIG. 6a. In FIG. 6b, a video denoise (VDN) block 615 is added at the front of the SRRS component 600a and receives the input frame (FRAME_{IN}) 610. The video denoise (VDN) block 615 is intended to accommodate a wide range of conventional noise filtering options, including spatiotemporal filter structures. The significant point is that noise filtering of the input frame (FRAME_{IN}) 610 will improve SRRS modulation response, again based upon an improved PW/SFSR_{NR,U,D} pattern manifold response.

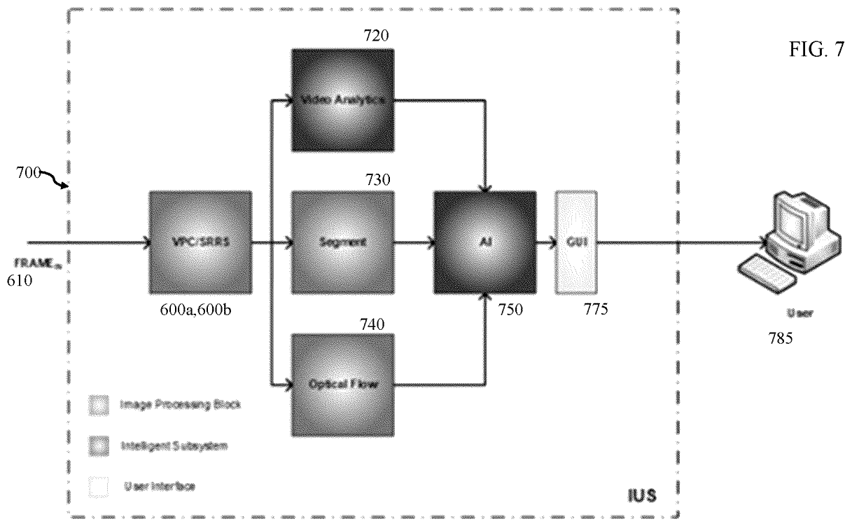

As previously mentioned, image understanding QoR hinges upon content SNR. Accordingly, as shown in FIG. 7, an AI-based image-understanding system 700 provides enhanced performance based upon joint application of VPC/SRRS signal conditioning output from block 600a,600b, to three distinct information processing branches: video analytics 720, video segmentation 730, and optical flow 740, whereby a three-fold performance improvement is obtained by the Artificial Intelligence component 750, which outputs the improved video using a graphical user interface 775 interfacing with an end user 785. The three-fold performance improvement includes: (i) reduced Machine Learning/Neural Network (ML/NN) classifier error rate, (ii) improved segmentation boundary accuracy, and (iii) improved optical flow-field accuracy.

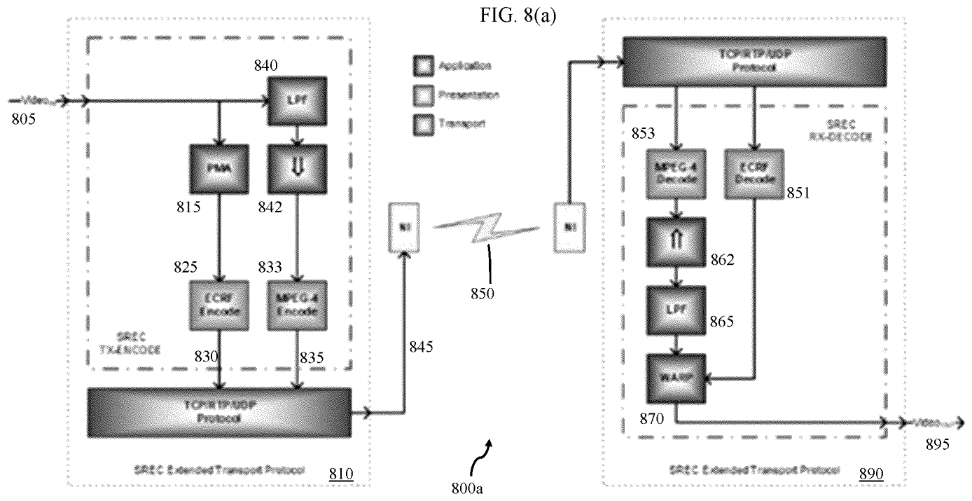

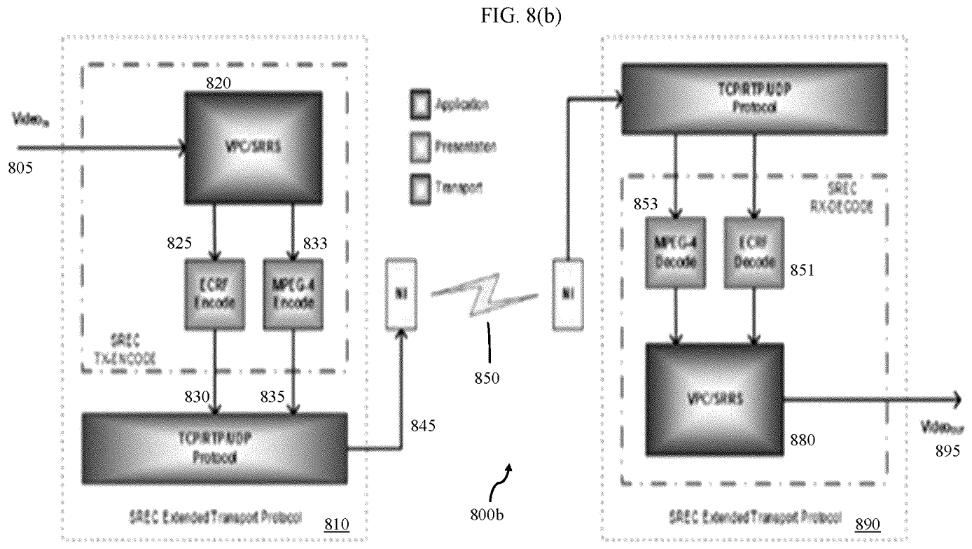

In another example, FIG. 8(a) illustrates a ‘Source-Encoded’ SRE/CODEC (time-domain) model 800a, described in more detail in Anderson, U.S. patent application Ser. No. 17/928,842, entitled “Improved Superresolution-Enabled (SRE) Video CODEC,” filed Nov. 30, 2022, which is incorporated by reference herebelow. As shown, source input video (Video_{IN}) 805 is provided to an ENCODE transmitter 810. The ENCODE transmitter 810 performs image instancing using a Pattern Manifold Assembly (PMA) 815 and an Edge-Contours Reconstruction Filter (ECRF) encoder 825. ENCODE components include descriptor fields for each generated ECRF instance along with the edge-contours identified during PMA 815. Image downsampling is performed via an initial (FIR/Anti-Aliasing) Low-Pass Filter (LPF) 840 followed by downsampling 842 and MPEG-4 encoding 833. The ECRF ENCODE data 830, output by the ECRF 825, is combined with stage-2 lossy compressor output 835, and is conventionally (e.g., TCP,RTP,UDP) transmitted 850 as a total transmission payload 845 to the receiver 890.

Once received, the payload 845 is provided to an MPG-4 decoder 853 and to an ECRF DECODE processor 851. Once decompressed by the MPEG-4 decoder 853, the data is upsampled 862 and passed through an anti-alias filter 865 for removal of higher order spectral images. Total compression is the product of stage-2 lossy compression and reduced downsample/resample scale factor (‘N_{RSF}’) squared. The output from the ECRF decoder 865 and the ECRF decoder 851 are provided to warp-reconstruction (WARP) process components 870, which provides the video output (Video_{OUT}) 895.

As shown in FIG. 8(b), VPC/SRRS components 820, 880 can be substituted to create an improved Superresolution-Enabled Video CODEC (SREC) architectural form 800b. Aside from an obvious functional encapsulation at both TX-ENCODE 810 and RX-DECODE 890, the benefit to be gained by replacing PW/SFSR fabric from FIG. 8(a) with the VPC/SRRS fabric of FIG. 8(b) is an improved overall noise performance by which an increased compression capability may be achieved. With such improvement to what may be considered a generic transport functionality, similar improvements are extended to systems incorporating VPC/SRRS enhanced SREC.

A number of video systems to which the VPC/SRRS SREC enhancement described above, in addition to the SVD functionality described below, may be applied are described above in FIGS. 1(a)-1(e). Additional examples (not shown) of VPC/SREC enhanced applications include: (i) Video Production; (ii) VR/AR HUD; and (iii) Video analytics.

### H. Adaptive Spatiotemporal Video Denoise Functionality

During preliminary testing, a Spatiotemporal Video Denoise (SVD) formalism was applied to content in which an admixture of additive and multiplicative noise sources were present. Although originally targeted to noise filtering of Near-Infrared Optical Coherence Tomography (NI/OCT) datacubes, it is believed that the underlying formalism can be used for a broader set of applications. In terms of denoise performance, SVD was shown most effective where noise estimates are updated directly from source content. As originally conceived, this noise sampling was performed on some reserved image sector, prequalified in terms of statistical properties. Although successful, the prescan and analysis steps required for noise sample assembly hinder process pipelining and thus constitutes a substantial impediment to SVD production deployment.

We address these problems via an alternative noise sampling scheme based upon dual-use of Spatiotemporal Volumes (STV) assembled as pixel-estimation buffers; the fact STV's are content-aligned admits treatment as a stochastic time-series from which both signal and noise process estimates may be extracted. In this manner, an arbitrary frame may be processed as a fully pipelined adaptive sample space with per-pixel concurrency. In what follows, noise samples thus obtained are shown to exhibit an increased statistical efficiency leading to an improved filter response.

In most general terms, the spatiotemporal formalism is favored in video noise filtering applications due to an inherent encapsulation and averaging of noise sample ensembles, enabling both a direct noise floor reduction and improved estimation accuracy. In recent work, the spatiotemporal estimation concept has been extended to noise filtering of OCT diagnostic image cubes in which a characteristic multiplicative ‘speckle’ noise process predominates. MMSE optimal noise transfer is obtained via a multidimensional Weiner filter formulation whereby multiplicative noise is approximated as a non-stationary additive process exhibiting significant noise/signal cross-correlation. In benchmark tests, the Spatiotemporal Video Denoise (SVD) filter structure exhibited an effective noise attenuation with minimal loss of image sharpness or detail. In subsequent experimentation this result was extended to generic content in which both additive and multiplicative noise sources are present.

As discussed herein, the noise sampling component is focused upon, whereby calculation of a given filter transfer function hinges upon accuracy of component PSD estimator terms. It then follows that a reduced filter performance may be expected where PSD estimators do not accurately reflect actual noise process statistics. In particular, noise samples are preferably not corrupted by residual signal information in generation of statistical bias. This requirement forms the basic selection criterion for a candidate noise sample space; to the extent PSD estimators exhibit bias, a suboptimal noise transfer may accrue.

As originally conceived, SVD noise estimation hinges upon prespecification of contiguous image sample regions, noise-like and persistent over successive frames. However, despite achieving an effective filter realization, it became apparent sample regions meeting these requirements are not generally available for all content of interest. Further, the prescan and analysis steps implicit to prespecification are sequential/blocking on an SVD process schedule and thus incompatible with Amdahl acceleration as a concurrent streaming process. As discussed in greater detail herein, these problems are addressed via a schema in which per-pixel noise sample ensembles are extracted directly from spatiotemporal estimation buffers. In this manner, image sample regions are adaptively rendered as complete frames obviating any requirement for special content structure. This fully adaptive SVD (ASVD) is thus rendered as a parallelizable streaming process on arbitrary signal-plus-noise mixtures.

### I. Spatiotemporal Filter Formalism

Spatiotemporal processing is inherently nonlocal in that datacubes assembled as domain support for noise filtering and pixel estimation are motion compensated (MC). In most general terms, a datacube occurring at given coordinates may be regarded as an aligned sample-space within which pixel-content will add coherently and noise incoherently. It then follows that pixel-content present within the datacube is, to the limits of MC match criteria, an approximately constant term in principle removable via a simple subtraction. In such manner, datacubes are rendered as noise sample ensembles applicable to low-variance estimation of all statistical variables. Multiframe datacubes are, thus, dual-purposed as source for both noise and pixel estimates. This capability is leveraged in the proposed ASVD architecture as means to achieve fully-adaptive estimation of noise filter transfer characteristics with no requirement for a reserved noise sample region.

In what follows, spatiotemporal estimation on an assumed image representation ‘I(x,y)’ hinges upon expression of pixel values in terms of overlapping local patches of dimension ‘(2N+1)×(2N+1)’ centered at coordinates ‘x±kΔx, y±lΔy’:

$$I ( {x}_{i} , {y}_{j} ) = \frac{1}{{N}^{2}} {\sum }_{k = 0}^{N - 1} {\sum }_{l = 0}^{N - 1} {I}^{kl} ( {x}_{i} , {y}_{j} ) \qquad ( 13 )$$

Replacing each ‘Iₖₗ’ with an estimator on ‘N_{MC}’ motion-compensated copies gives:

$$\hat{I} ( {x}_{i} , {y}_{j} ) = \frac{1}{{N}_{MC} {N}^{2}} {\sum }_{kl} {\sum }_{s = 0}^{M - 1} {I}^{kls} ( {x}_{i} , {y}_{j} ) \qquad ( 14 )$$

All spatiotemporal noise filtering can then be expressed in terms of spectral representation. Thus, applying Fourier Transform to Equation (14) gives:

$${F}_{2 D} ( \hat{I} ( x , y ) ) = \frac{1}{{N}_{MC} {N}^{2}} {\sum }_{kls} {I}_{2 D}^{kls} ( μ , v ) = {\hat{I}}_{2 D} \qquad ( 15 )$$

Datacube instances are then defined in terms of a total temporal ordering relation on sample-sets

$${}^{‵} {\{ {I}_{2 D}^{kls} \}}^{′} .$$

Datacube slices then accrue as ‘(2N+1)×(2N+1)’ matrices at indices ‘s←m|me{0, N_{MC}−1}’.

A spectral representation and operational transform pair well-suited to spatiotemporal noise filtering is obtained via 1D cepstral transform of Fourier components at each slice coordinate ‘{k, l}’:

$${F}_{1 Dx 2 D} ( \hat{I} ( x , y ) ) = \frac{1}{{N}_{MC} {N}^{2}} {\sum }_{kls} {F}_{1 D} ( {\hat{I}}_{2 D}^{kls} ) = \frac{1}{{N}_{MC} {N}^{2}} {\sum }_{kls} {I}_{1 Dx 2 D}^{kls} ( μ , v , ω , ξ ) ≡ {\hat{I}}_{1 Dx 2 D} \qquad ( 16 a )$$

$$\hat{I} ( x , y ) = {F}_{2 D}^{- 1} ( {F}_{1 D}^{- 1} ( {\hat{I}}_{1 Dx 2 D} ) ) = {F}_{2 Dx 1 D}^{- 1} ( {\hat{I}}_{1 Dx 2 D} ) \qquad ( 16 b )$$

Spatiotemporal Volumes (STV) are then rendered as rank ‘(3,0)’ tensors via:

$${STV}_{1 D ∨ 2 D ∨ 1 Dx 2 D}^{αβ s} = {I}_{1 D ∨ 2 D ∨ 1 Dx 2 D}^{αβ} {1}^{s} \qquad ( 17 )$$

Where: (i) ‘1D’ and ‘2D’ Fourier transforms may be applied in any combination, (ii) ‘α’ and ‘β’ are to be understood as free-indices on datacube slice tensors, and (iii) ‘1^{s}’ is a tensor 1-form consisting of entry ‘1’ in all positions ‘s’. Further, Equations (13)-(17) are employed as a basic representational format for frame estimation where optimal noise filtering is applied to pixel-estimates generated on spatiotemporal tensors ‘STV^{α/β}’.

### J. ASVD Noise Model

For purposes of ASVD noise estimation and filtering, it should be assumed that an observation model in which a composition of both multiplicative and additive noise sources is presented by:

$$y = n ⊗ A ( x ) + η \vert E ( n ) = 1 , E ( η ) = 0 \qquad ( 18 )$$

Multiplicative noise is given as a Hadamard product of noise process ‘n’ and forward map ‘A’. Additive noise is represented as process ‘η’ typically consisting of characteristic thermal and shot-noise processes. We therefore write:

$$y = Ax + ( n - 1 ) ⊗ Ax + η = Ax + ε + η = Ax + e ) \qquad ( 19 )$$

Thus, an exact marginalization over ‘e’ then yields an expectation model represented by:

$$π ( y / x ) = {π}_{e / x} ( y - Ax / x ) ) \qquad ( 20 )$$

With stated assumptions on ‘n’ and ‘η’, and ‘E(e)=ê’:

$$e = \hat{η} + ( \hat{n} - 1 ) ⊗ A \hat{x} \qquad ( 21 )$$

Thus, ‘ê=0’ for the composite noise process as required. Further, for the joint covariance we have:

$${Γ}_{x , e} = ( \begin{matrix}{Γ}_{x , x} & {Γ}_{x , e} \\ {Γ}_{e , x} & {Γ}_{e , e}\end{matrix} ) \qquad ( 22 a )$$

$${Γ}_{ee} = {Γ}_{ηη} + {Γ}_{nn} ⊗ A {Γ}_{xx} {A}^{t} \vert {Γ}_{ex} = {Γ}_{xe} = {Γ}_{η x} \qquad ( 22 b )$$

For the conditional covariance, we then have:

$${Γ}_{e / x} = {Γ}_{η η} + {Γ}_{nn} ⊗ A {Γ}_{xx} A - {Γ}_{η x} {Γ}_{xx}^{- 1} {Γ}_{x η} \qquad ( 23 )$$

Note, where ‘Γ_{e/x}’ is full-rank, the approximate likelihood model is given by:

$$π ( y / x ) = {π}_{e / x} ( y - Ax / x ) ∝ {e}^{( - \frac{1}{2} {‖ y - Ax - \hat{η} - {Γ}_{η x} {Γ}_{xx}^{- 1} ( x - \hat{x} ) ‖}_{2}^{2} )} \qquad ( 24 a )$$

$${Γ}_{e / x}^{- 1} = {Γ}_{e / x}^{t} {Γ}_{e / x} \qquad ( 24 b )$$

An approximating additive-noise observation model is then inferred based upon the likelihood model in Equation (12a) and (12b) as:

$$y = Ax + {η}^{′} \vert E [ {η}^{′} ] = 0 \qquad ( 25 )$$

Note this result is generic by virtue of the fact it is not conditioned upon any independent and identically distributed (IID) assumption with respect to processes ‘n’ and ‘η’. We then develop a noise filter to be applied to the observation model in Equation (25), specification of which hinges upon accurate characterization of the composite additive noise process ‘η’.

### K. Spatiotemporal Noise Filter

As described above, spatiotemporal noise filter processing is based upon pixel and noise estimates derived from a multi-frame sample-set aligned temporally via some cyclic buffering scheme and spatially via motion estimation. Accordingly, all such sample ensembles are cast as STV^{α/β} tensors.

In assembly of these tensors, we note the assumed motion-compensation implies estimates are derived from samples occurring at a distribution of frame coordinates. Thus, derived sample-ensembles are appropriately cast as nonlocal. However, per Equations (18)-(25) that same motion-compensation also implies uniformity of noise processes for each s-index value assignment. As will be shown herein, it is this singular property of the SVD formalism that enables optimal filtering of multiplicative noise-sources.

Per Equations (4a) and (4b), it is assumed all estimation is performed in transform-space, enabling independent application of noise filter transfer functions along spatial and temporal axes via generalized Hadamard products. Frame content estimates then accrue as a tensor product:

$${\hat{I}}_{Ax}^{αβ} = \frac{( {STV}^{αβ s} ⊗ {F}_{SVT}^{αβ s} )}{{N}_{MC}} {1}_{s} \qquad ( 26 )$$

### Where,

$${}^{′} {{F}_{S ⋁ T}^{αβ s}}^{′}$$

is some linear filter cast in form of a [3,0] contravariant tensor. In principle, any linear filter construct may be employed. However, in subsequent development, we will adopt an MMSE optimal Wiener filtering principle incorporating Power Spectral Densities (PSD) referenced to noise/signal terms given by Equation (25).

As displayed in Equation (27) below, noise filter transfer characteristics are captured in form of a Noise Filter-tensor (NF-tensor), component PSDs of which are calculated via element-wise application of the Wiener-Khinchin theorem to raw noise/signal cross-correlations per Equation (17). This representation is employed so as to admit filter application as a generalized Hadamard product defined on tensor operands of equal rank:

$${F}_{S ⋁ T}^{αβ} = \frac{{S}_{AX , Ax}^{α β} + \vert {S}_{{η}^{′} , Ax}^{αβ} \vert}{{S}_{Ax , Ax}^{αβ} + 2 \vert {S}_{{η}^{′} , Ax}^{αβ} \vert + {S}_{{η}^{′} , {η}^{′}}^{αβ}} \qquad ( 27 )$$

Referring to Equations (16) and (17) above, it should be noted that STV-tensor assembly engenders distinct spatial and temporal spectral representations based upon application of successive Fourier Transforms along orthogonal axes. Thus, given a noise filter must be applied to the correct filter domain, NF-tensors are necessarily applied in a complementary two-stage process:

$${STV}_{S ∧ T}^{α β s} = {F}_{S}^{α β s} ⊗ {STV}_{T}^{α β s} = {F}_{S}^{α β s} ⊗ {ℱ}_{1 D}^{- 1} ( {F}_{T}^{α β s} ⊗ {STV}_{1 D \times 2 D}^{α β s} ) \qquad ( 28 )$$

Where subscripts ‘S’ and ‘T’ reference spatial and temporal filter domains, respectively. Local patch estimates are then calculated via a scaled contraction of the filtered STV-tensor followed by a final inverse Fourier Transform:

$$\hat{I} ( {x}_{i} , {y}_{j} ) = {ℱ}_{2 D}^{- 1} ( {\hat{I}}^{αβ} ) = {ℱ}_{2 D}^{- 1} ( \frac{{STV}_{S ∧ T}^{α β s}}{{N}_{MC}} ) \qquad ( 29 )$$

### L. Adaptive Noise Estimation

It is noteworthy that additive approximation to the noise model in Equation (18) does not change the underlying statistics. Rather, the model serves to enable observation of those statistics in terms of the PSDs appearing in Equation (27). In essence, the approximation allows one to obtain an unbiased additive estimator but at cost of time invariance; under circumstances where the noise/signal covariance is nonzero, the likelihood model is rendered level-dependent and the composite noise process ‘η’ in Equation (25) is rendered nonstationary. This result forms an essential motivation for frame-to-frame recalculation of the multidimensional noise filter transfer characteristic displayed in Equation (26). It is significant, this recalculation will hinge upon availability of a signal estimate as a statistical prior to the cross-correlations appearing in Equation (27).

Under circumstances where datacube slice noise content may be claimed independent and identically distributed (IID), a simple expectation on a ‘signal-plus-noise’ STV-tensor will provide an LLN reduced variance signal estimate. Following Equation (29), we then have:

$$\hat{I} ( {x}_{i} , {y}_{j} ) = {ℱ}_{2 D}^{- 1} ( {\hat{I}}_{Ax}^{αβ} ) = {ℱ}_{2 D}^{- 1} ( \frac{{STV}_{2 {D}_{Ax + η}}^{α β s} {1}_{s}}{{N}_{MC}} ) \qquad ( 30 )$$

Alternative estimators may also prove useful pending an extended analysis. For example, following Equation (17), a noise-process tensor can be assembled via the following Equations (31a)-(31c):

$${STV}_{Ax}^{α β s} = {ℱ}_{2 D} ( \hat{I} ( {x}_{i} , {y}_{j} ) ) = {ℱ}_{2 D} ( {\hat{I}}_{Ax}^{αβ} ) \qquad ( 31 a )$$

$${STV}_{{η}^{′}}^{α β s} = {ℱ}_{2 D} ( {I}_{Ax + {η}^{′}}^{αβ} - {\hat{I}}_{Ax}^{αβ} ) \qquad ( 31 b )$$

$${STV}_{Ax + {η}^{′}}^{αβ} = {ℱ}_{2 D} ( {I}_{Ax + {η}^{′}}^{αβ} ) \qquad ( 31 c )$$

These tensors enable adaptive update of the noise filter transfer characteristic in Equation (26) and component PSDs in Equation (27) via the following Equations (32a)-(32d):

$${STV}_{{η}^{′} , {η}^{′}}^{αβ} = {STV}_{{η}^{′}}^{αβ} ⊗ {STV}_{{η}^{′}}^{αβ} \qquad ( 32 a )$$

$${STV}_{Ax , Ax}^{αβ} = {STV}_{Ax}^{αβ} ⊗ {STV}_{Ax}^{αβ} \qquad ( 32 b )$$

$${STV}_{Ax + {η}^{′} , Ax + {η}^{′}}^{αβ} = {STV}_{Ax + {η}^{′}}^{αβ} ⊗ {STV}_{Ax + {η}^{′}}^{αβ} \qquad ( 32 c )$$

$${STV}_{Ax + {η}^{′}}^{αβ} = \frac{1}{2} ( {STV}_{Ax , Ax}^{αβ} + {STV}_{{η}^{′} , {η}^{′}}^{αβ} - {STV}_{Ax + {η}^{′} , Ax + {η}^{′}}^{αβ} ) \qquad ( 32 d )$$

It should be noted that while the estimators in Equations (32a)-(32d) are in fact biased due to the mean estimator employed in Equations (31a)-(31b), the noise transfer estimator in Equation (27) remains unbiased due to cancellation of a common bias-correction factor.

### M. ASVD Processing Architecture

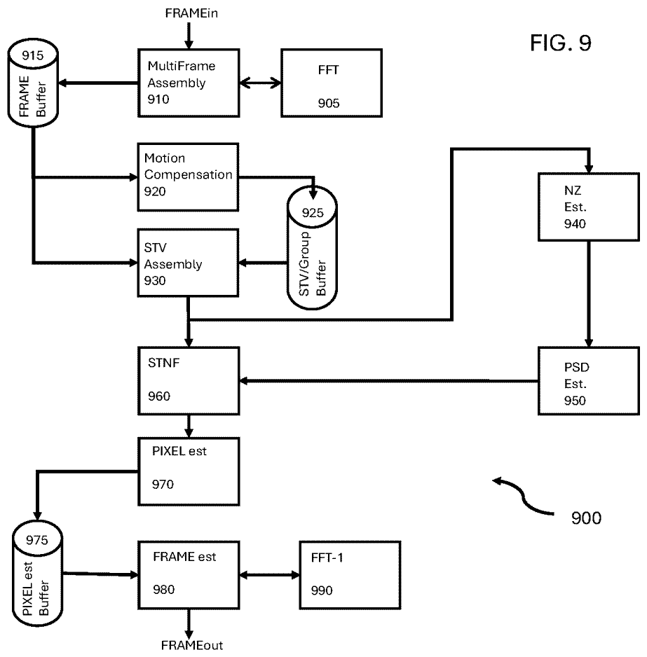

For purposes of machine processing, the ASVD formalism previously discussed is rendered in FIG. 9, as a five-stage feedforward dataflow architectural form 900, which includes: (i) a multiframe assembly 910, (ii) motion compensation 920, (iii) noise filter estimation 930-950, (iv) pixel estimation 970, and (v) frame estimation 980.

The ASVD operational sequence is summarized as follows: In Multiframe Assembly, successive frames (FRAMEin) are expanded as overlapping local patches, each of which is operationally transformed (FFT) 905 and cyclically buffered 915 according to a predefined depth, (re: parameter ‘M’ in Equations (14)-(16). Motion Compensation 920 detects frame-to-frame shifts in local patch coordinates according to a defined metric. Any detected shifts are appended to an associated STV linked-list 930 and buffered 925. As previously described, Noise Filter Estimation is comprised of a three-stage subprocess; (i) STV Assembly 930, (ii) Noise Estimation 940, (iii) PSD Estimation and Noise Filter (NF) transfer characteristic update 950. In Pixel Estimation 970, the updated NF is applied to the STV 960 and buffered 975. In Frame Estimation 980, an inverse FFT 990 is applied to buffered pixel estimates and written to a frame accumulation buffer. Once all pixel estimates are accumulated, a frame estimate is calculated, and a noise filtered version of the most recent frame is output (FRAMEout).

### N. ASVD Application Templates

ASVD is intended as a generic video processing pipeline building-block. Aside from standard noise filtering applications, ASVD is usefully applied to problem domains considered difficult due to; (i) presence of an admixture of additive and multiplicative noise sources and (ii) absence of an accurate a priori noise process characterization. As previously discussed, ASVD addresses the first problem via approximation of multiplicative noise sources as additive sources and the latter via realtime assembly and sampling of noise statistics ensembles extracted directly from STV (raw) data buffers. Exemplary application domains include but are not limited to: (i) streaming video total denoise; (ii) Superresolution-Enabled Video CODEC (SREC); (iii) Machine Learning (ML) classifier optimization; (iv) film restoration; (v) OCT medical imaging; and (vi) RADAR/SONAR total denoise.

We now consider a succession of application scenarios enabled by ASVD. In FIG. 6b above, ASVD can be employed as a video preconditioning (VPC) pipeline preprocessing block (where FRAMEin 610 is filtered at 615 before being fed to block 620) for which a twofold advantage is obtained; (i) enhanced superresolution processing-gain and (ii) overall improved image resolution and SNR. These advantages are extended in FIG. 7 to an enhanced image understanding system (IUS), by virtue of an improved AI/ML classifier error rate.

In yet another exemplary application scenario, we see in FIG. 8(b) VPC/SRRS/ASVD integration with the superresolution-enabled video CODEC (SREC) architecture. The singular advantage of this arrangement is realization of an extended compression-rate potential based upon an enhanced edge-contour reconstruction filter (ECRF) ENCODE. This advantage is then extended to higher-order system architectures that employ the enhanced SREC kernel-stack for internet transport. For example, we see in FIG. 1(b) instancing of SREC/VPC/ASVD functionality in a video streaming system, and in FIG. 1(a) this same functionality is applied to an loT video surveillance system.

### O. Incorporations by Reference

This application references, and incorporates herein in their entirety, each of the following U.S. Patents and/or applications:
{1}P. Topiwala, “Real-Time Superresolution and Video Transmission,” U.S. Pat. No. 8,520,736, issued Aug. 27, 2013.
{2}J. H. Elton, et al., “Methods and Systems for Up-Scaling a Standard Definition (SD) Video to High Definition (HD) Quality,” U.S. Pat. No. 8,639,053, issued Jan. 28, 2014.
{3}L. Hurd, et al., “Methods and Systems for Upscaling a Standard Definition (SD) Video to High Definition (HD) Quality,” U.S. Pat. No. 8,983,236, issued Mar. 17, 2015.
{4}L. Hurd, et al., “Systems and Methods for Upscaling Video,” U.S. Pat. No. 9,432,616, issued Aug. 30, 2016.
{5}J. B. Anderson, “Improved Superresolution-Enabled (SRE) Video CODEC,” U.S. patent application Ser. No. 17/928,842, filed Nov. 30, 2022, and all related continuations, continuations-in-part, divisionals, and reissues and any other patents or applications claiming priority therefrom.

For purposes of illustration, application programs and other executable program components such as the operating system may be illustrated herein as discrete blocks, although it is recognized that such programs and components reside at various times in different storage components of the computing device, and are executed by the data processor(s) of the computer. An implementation of media manipulation software can be stored on or transmitted across some form of computer readable media. Any of the disclosed methods can be executed by computer readable instructions embodied on computer readable media. Computer readable media can be any available media that can be accessed by a computer. By way of example and not meant to be limiting, computer readable media can comprise “computer storage media” and “communications media.” “Computer storage media” comprises volatile and non-volatile, removable and non-removable media implemented in any methods or technology for storage of information such as computer readable instructions, data structures, program modules, or other data. Exemplary computer storage media comprises, but is not limited to RAM, ROM, EEPROM, flash memory or memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent system (e.g. expert interference rules generated through a neural network or production rules from statistical learning).

In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an API, reusable controls, or the like. Such programs may be implemented in a high level procedural or object-oriented programming language to communicate with a computer system. However, the program(s) can be implemented in assembly or machine language. In any case, the language may be a compiled or interpreted language and it may be combined with hardware implementations.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be affected across a plurality of devices. Such devices might include PCs, network servers, mobile phones, softphones, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

I hereby claim:

1. An improved method for transmission of a source video from a first location to a second location, wherein there is limited transmission bandwidth available between the first location and the second location, wherein the source video has a plurality of sequentially-ordered frames of images and has an original spatial sample rate, the source video is encoded to create a compressed video, the compressed video is received at the second location and then decoded and decompressed to create an output video, and the output video is then displayed to one or more recipients, the improved method comprising:
Encoding the source video to create the compressed video includes the steps of: (i) applying anti-alias, low-pass filtering to the source video; (ii) downsampling the low-pass filtered video to a reduced spatial sample rate lower than the original spatial sample rate, and then (iii) compressing the downsampled video using a lossy codec so that the compressed video has a further reduced spatial sample rate and is smaller in size than the source video; and,
After transmitting the compressed video from the first location to the second location, decoding the compressed video includes the steps of: (i) decompressing the compressed video using the lossy codec, (ii) upsampling the decompressed video, and then (iii) applying photometric warp superresolution processing to each frame of the upsampled video to create the output video, wherein the output video has a resolution less than the source video,
further comprising applying adaptive spatiotemporal noise filtering to each frame of the source video prior to the step of encoding to improve the sharpness of the output video.

2. The method of claim 1 wherein applying adaptive spatiotemporal noise filtering comprises the step of multiframe assembly whereby successive frames of the source video are expanded as overlapping local patches.

3. The method of claim 2 wherein each of the overlapping patches is operationally transformed and cyclically buffered.

4. The method of claim 1 wherein applying adaptive spatiotemporal noise filtering comprises the step of applying motion compensation whereby frame-to-frame shifts in local patch coordinates between successive frames of the source video are detected and appended to an associated spatiotemporal volume (STV) list and buffered.

5. The method of claim 4 wherein applying adaptive spatiotemporal noise filtering further comprises the step of applying noise filter estimation to each frame of the source video.

6. The method of claim 5 wherein the step of applying noise filter estimation comprises the steps of assembling the buffered STV list, applying noise estimation, and applying power spectral density and noise filter transfer characteristics updates to each frame of the source video.

7. The method of claim 6 wherein applying adaptive spatiotemporal noise filtering comprises the steps of applying pixel estimation and frame estimation to each frame of the source video.

8. The method of claim 7 wherein applying pixel estimation comprises applying the updated noise filter characteristics to the buffered STV list.

9. The method of claim 8 wherein applying frame estimation comprises applying an inverse transformation to the buffered pixel estimates and writing the buffered pixel estimates to a frame accumulation buffer and wherein once all buffered pixel estimates are accumulated, a frame estimate is calculated, and a noise filtered version of the most recent frame of the source video is output.

10. An improved system for transmission of a source video over a network having limited transmission bandwidth, wherein the source video has a plurality of sequentially-ordered frames of images and has an original spatial sample rate, wherein the source video is converted to a compressed video prior to transmission, and after transmission the compressed video is converted to an output video, and the output video is then displayed to one or more recipients, the improved system comprising:
An encoder converts the source video into the compressed video by: (i) processing the source video through an anti-alias, low-pass filter, (ii) downsampling the low-pass filtered video to a reduced spatial sample rate lower than the original spatial sample rate, and then (iii) compressing the downsampled video using a lossy codec so that the compressed video has a further reduced spatial sample rate and is smaller in size than the source video;
A transmitter receives the source video from the encoder and transmits the compressed video over the network to a receiver;
A decoder receives the compressed video from the receiver generates the output video by: (i) decompressing the compressed video using the lossy codec, (ii) upsampling the decompressed video using an anti-image filter, and then (iii) applying photometric warp superresolution processing to each frame of the upsampled video to create the output video, wherein the output video has a resolution less than the source video, and
further comprising a processor that applies adaptive spatiotemporal noise filtering to each frame of the source video prior to providing each frame of the source video to the encoder.
